(19) United States
(12) Patent Application Publication
(10) Pub. No.: US 2006/0138955 A1
(43) Pub. Date: Jun. 29, 2006

(54) PLASMA DISPLAY PANEL AND MANUFACTURING METHOD THEREOF

(75) Inventors: Myung Won Lee, Seocho-gu (KR); Won Seok Jeon, Suwon-si (KR)

Correspondence Address: FISH & RICHARDSON P.C., P.O. BOX 1022, MINNEAPOLIS, MN, 55440-1022, US

(73) Assignee: LG Electronics Inc., Yongdungpo-gu (KR)

(21) Appl. No.: 11/275,334

(22) Filed: Dec. 23, 2005

(30) Foreign Application Priority Data
Dec. 24, 2004 (KR) 10-2004-0112478

(51) Int. Cl. H01J 17/49

(52) U.S. Cl. 313/582

(57) ABSTRACT

This document relates to a plasma display panel and manufacturing method thereof, and more particularly, to a plasma display panel and manufacturing method thereof, in which the uniformity of a black layer and the yield can be improved. The plasma display panel according to an embodiment of the present invention comprises a front glass substrate, a transparent electrode formed on the front glass substrate in a discharge region, an adhesive agent formed at least on a portion of the front glass substrate in a non-discharge region and a black layer formed on the adhesive agent in the non-discharge region. In the method of manufacturing the plasma display panel according to an embodiment of the present invention, a process of forming the front panel comprises the steps of (a) coating a transparent electrode paste and an adhesive paste on a glass substrate, (b) disposing a mask on the transparent electrode and the adhesive agent, (c) irradiating a top surface of the mask with a amount of light to form a transparent electrode pattern and a adhesive pattern, and (d) coating a black paste on the transparent electrode pattern and the adhesive pattern to form a black layer.

### CROSS-REFERENCES TO RELATED APPLICATIONS

This Nonprovisional application claims priority under 35 U.S.C. § 119(a) on Patent Application No. 10-2004-0112478 filed in Korea on Dec. 24, 2004 the entire contents of which are hereby incorporated by reference.

### BACKGROUND OF THE INVENTION

1. Field of the Invention

This document relates to a display apparatus, and more particularly, to a plasma display panel and manufacturing method thereof.

2. Background of the Related Art

In general, a plasma display apparatus of a display apparatus comprises a plasma display panel and a driver for driving the plasma display panel.

A plasma display apparatus comprises a plasma display panel having a front substrate and a rear substrate. A barrier rib formed between the front substrate and the rear substrate forms one unit cell. Each cell is filled with a primary discharge gas, such as neon (Ne), helium (He) or a mixed gas of Ne+He, and an inert gas containing a small amount of xenon (Xe). If the inert gas is discharged with a high frequency voltage, vacuum ultraviolet rays are generated. Phosphors formed between the barrier ribs are excited to implement images. The plasma display panel can be made thin, and has thus been in the spotlight as the next-generation display devices.

FIG. 1 is a perspective view illustrating the construction of a general plasma display panel. As shown in FIG. 1, the plasma display panel comprises a front substrate 100 and a rear substrate 110. In the front substrate 100, a plurality of sustain electrode pairs in which scan electrode 102 and sustain electrode 103 are formed in pairs is arranged on a front substrate 101 serving as a display surface on which images are displayed. In the rear substrate 110, a plurality of address electrode 113 crossing the plurality of sustain electrode pairs is arranged on a rear substrate 111 serving as a rear surface. At this time, the front substrate 100 and the rear substrate 110 are parallel to each other with a predetermined distance therebetween.

The front substrate 100 comprises the pairs of scan electrode 102 and sustain electrode 103, which mutually discharge one another and maintain the emission of a cell within one discharge cell. In other words, each of the scan electrode 102 and the sustain electrode 103 has a transparent electrode “a” formed of a transparent ITO material and a bus electrode “b” formed of a metal material. The scan electrode 102 and the sustain electrode 103 are covered with one or more dielectric layers 104 for limiting a discharge current and providing insulation among the electrode pairs. A protection layer 105 having Magnesium Oxide (MgO) deposited thereon is formed on the dielectric layers 104 so as to facilitate discharge conditions.

In the rear substrate 110, barrier ribs 112 of stripe form (or well form), for forming a plurality of discharge spaces, i.e., discharge cells are arranged parallel to one another. Furthermore, a plurality of address electrode 113, which generate vacuum ultraviolet rays by performing an address discharge, are disposed parallel to the barrier ribs 112. R, G and B phosphor layers 114 that radiate a visible ray for displaying images during an address discharge are coated on a top surface of the rear substrate 110. A dielectric layer 115 for protecting the address electrode 113 is formed between the address electrode 113 and the phosphor layers 114.

The related art plasma display panel constructed above is formed through a substrate manufacturing process, a front panel manufacturing process, a rear panel manufacturing process and an assembly process. More particularly, the process of manufacturing the front panel of the plasma display panel manufacturing process.

FIG. 2 is a flowchart illustrating a method of manufacturing a front panel of a plasma display panel in the related art. As shown in FIG. 2, in step (a), ITO made of indium oxide and tin oxide is deposited to a predetermined thickness on a front substrate 10, which serves as a display surface on which images will be displayed, in the front panel by means of E-beam or a sputtering method to form transparent electrode 11a, 12a. A photoresist (A) is coated on the transparent electrode 11a, 12a. Photomasks (B) in which a predetermined pattern as shown in FIG. 3 is formed are placed on the photoresist (A). The photoresist is sintered by irradiating light. This process is called “exposure process”.

In the front substrate that has experienced the exposure process, the photoresist that has not been sintered is cleaned through a step (b), i.e., a development process, and sandblast or etching is then performed on the transparent electrode. Thereafter, the photoresist is stripped from the front substrate in step (c). Therefore, the transparent electrode 11a, 12a in scan electrode and sustain electrode are formed.

Thereafter, in step (d), a black layer paste 20 is coated on the front substrate 10 comprising the transparent electrode 11a, 12a. A photoresist (C) is coated on the black layer paste 20, which then experiences the exposure process as described above. The photoresist is stripped from the front substrate that has experienced the exposure process through a development process and an etching process as in step (e), thereby forming a black layer 20.

Thereafter, in step (f), a photosensitive silver (Ag) paste is printed on the black layer 20 by a screen printing method. Bus line electrode 11b, 12b are then formed by a photolithography method in the same manner as above. Thereafter, sintering is performed at a temperature of about 550° C. to form scan electrode and sustain electrode.

Thereafter, in step (g), a dielectric substrate paste is coated on the front substrate on which the scan electrode and the sustain electrode, and the black layer 20 are formed and is then dried. Sintering is then performed at a temperature of about 500 to 600° C. to form a dielectric layer 30. A protection layer 40 made of magnesium oxide (MgO) is formed on a top surface of the dielectric layer 30 by a Chemical Vapor Deposition (CVD) method, an ion plating method, a vacuum deposition method or the like, there completing the front panel of the plasma display panel.

The front substrate is formed in the manufacturing process of the plasma display panel as described above. Therefore, silver (Ag) constituting the bus electrode does not allow light by a discharge to pass through, but allows external light to reflect therefrom. Therefore, the black layer for improving contrast is formed between the transparent electrode and the bus electrode. However, the black layer formed on the front substrate has poor adhesive strength with substrate, generating a short black layer pattern and a partial peel-off phenomenon. As a result, a problem arises because the failure rate is increased and the production yield of a plasma display panel is lowered.

### SUMMARY OF THE INVENTION

Accordingly, an object of an embodiment of the present invention is to solve at least the problems and disadvantages of the background art.

It is an object of an embodiment of the present invention to improve the production yield of a plasma display panel.

It is another object of an embodiment of the present invention to decrease the failure rate by improving adhesive strength with a black layer and a front glass substrate formed in a front panel.

To accomplish the above objects, a plasma display panel according to an embodiment of the present invention comprises a front glass substrate, a transparent electrode formed on the front glass substrate in a discharge region, an adhesive agent formed at least on a portion of the front glass substrate in a non-discharge region and a black layer formed on the adhesive agent in the non-discharge region.

In a method of manufacturing a plasma display panel according to another embodiment of the present invention, a process of forming the front panel comprises the steps of (a) coating a transparent electrode paste and an adhesive paste on a glass substrate, (b) disposing a mask on the transparent electrode and the adhesive agent, (c) irradiating a top surface of the mask with a amount of light to form a transparent electrode pattern and a adhesive pattern, and (d) coating a black paste on the transparent electrode pattern and the adhesive pattern to form a black layer.

According to an embodiment of the present invention, in a manufacturing process of a plasma display panel, adhesive strength with a black layer and a front substrate formed in a front panel is improved. Therefore, there are advantages in that the failure rate can be decreased and the production yield can be enhanced.

### BRIEF DESCRIPTION OF THE DRAWINGS

The embodiment of the invention will be described in detail with reference to the following drawings in which like numerals refer to like elements.

FIG. 1 is a perspective view illustrating the construction of a general plasma display panel;

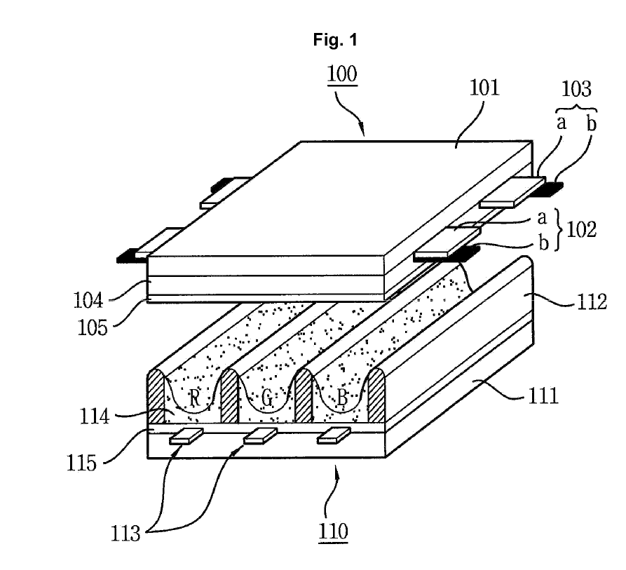

FIG. 2 is a flowchart illustrating a method of manufacturing a front panel of a plasma display panel in the related art;

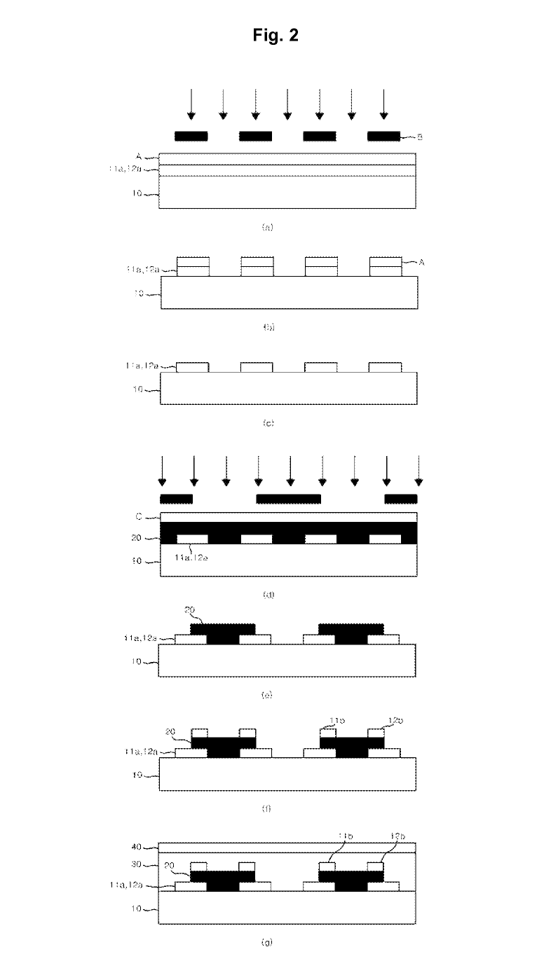

FIG. 3 shows a mask pattern used to manufacture the front panel of the plasma display panel in the related art;

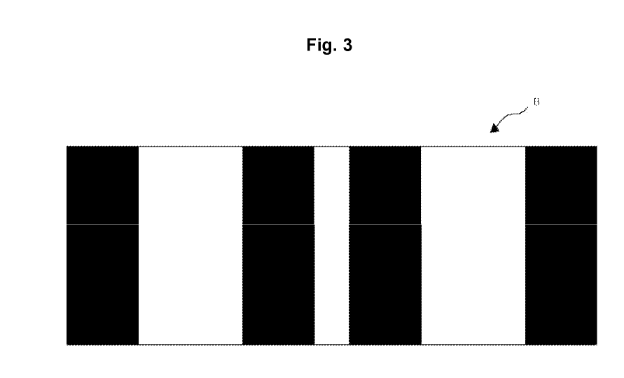

FIG. 4 shows the construction of a front panel of a plasma display panel according to an embodiment of the present invention;

FIG. 5 is a flowchart illustrating a method of manufacturing a plasma display panel according to an embodiment of the present invention;

FIG. 6 is a flowchart illustrating a process of manufacturing a front panel of a plasma display panel according to an embodiment of the present invention;

FIG. 7 shows a mask pattern used to manufacture the front panel of the plasma display panel according to an embodiment of the present invention; and

FIG. 8 shows a mask pattern used to manufacture the front panel of the plasma display panel according to an embodiment of the present invention.

### DETAILED DESCRIPTION OF THE PREFERRED EMBODIMENT

Embodiments of the present invention will be described in a more detailed manner with reference to the drawings.

A plasma display panel according to an embodiment of the present invention comprises a front glass substrate, a transparent electrode formed on the front glass substrate in a discharge region, an adhesive agent formed at least on a portion of the front glass substrate in a non-discharge region and a black layer formed on the adhesive agent in the non-discharge region.

The black layer is further formed on some portion of the transparent electrode

The plasma display panel further comprises a bus electrode formed on the black layer.

The adhesive agent and the transparent electrode are formed of an ITO material.

The adhesive agent has a dot pattern.

The dot pattern comprises one or more dots.

The adhesive agent has a line pattern.

The line pattern comprises one or more lines.

The transparent electrode comprises a pattern comprising a groove.

the pattern comprising the groove comprises one or more grooves.

In a method of manufacturing a plasma display panel according to another embodiment of the present invention, a process of forming the front panel comprises the steps of (a) coating a transparent electrode paste and an adhesive paste on a glass substrate, (b) disposing a mask on the transparent electrode and the adhesive agent, (c) irradiating a top surface of the mask with a amount of light to form a transparent electrode pattern and a adhesive pattern, and (d) coating a black paste on the transparent electrode pattern and the adhesive pattern to form a black layer.

The mask comprises a dot pattern.

The dot pattern is disposed at a location where the black layer is formed.

The mask comprises a line pattern.

The line pattern is disposed at a location where the black layer is formed.

The mask comprises a pattern comprising a groove.

The pattern comprising the groove is located on the transparent electrode.

An embodiment of the present invention will now be described in connection with reference to the accompanying drawings.

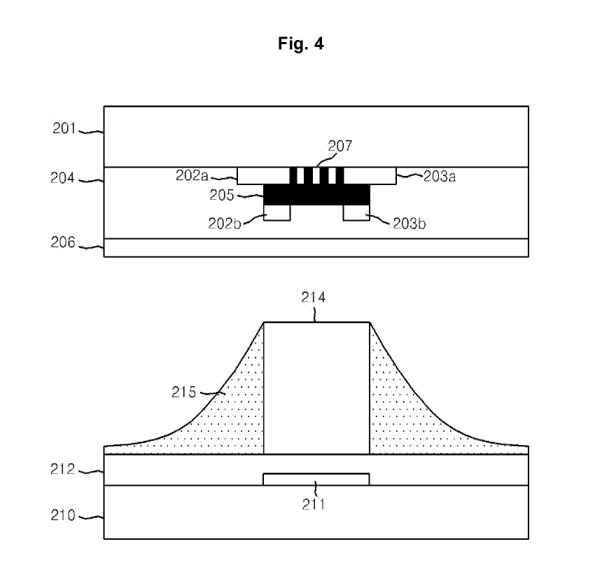

FIG. 4 shows the construction of a front panel of a plasma display panel according to an embodiment of the present invention.

As shown in FIG. 4, the plasma display panel comprises a front glass substrate 201 and a rear glass substrate 210. In the front glass substrate 201, a plurality of sustain electrode pairs in which scan electrode 202a, 202b and sustain electrode 203a, 203b are formed in pairs is arranged in a front glass substrate 201 serving as a display surface on which images are displayed. In the rear glass substrate 210, a plurality of address electrode 211 crossing the plurality of sustain electrode pairs is arranged on a rear glass substrate 210 serving as a rear surface. The front glass substrate 201 and the rear glass substrate 210 are parallel to each other.

The front glass substrate 201 comprises pairs of the scan electrode 202a, 202b and sustain electrode 203a, 203b, which mutually discharge within one discharge cell and sustain the emission of a cell. In other words, the scan electrode 202a, 202b and the sustain electrode 203a, 203b comprising transparent electrode 202a, 203a formed of a transparent ITO material and bus electrode 202b, 203b formed of a metal material. The transparent electrode 202a, 203a are formed on the front glass substrate 201 in a discharge region and an adhesive agent 207 is formed at least on a portion of the front glass substrate 201 in a non-discharge region.

Furthermore, if a black layer 205 is formed on the front glass substrate comprising some portion of the transparent electrode 202a, 203a and the adhesive agent 207, the bus electrode 202b, 203b are provided on the black layer 205.

Thereafter, the black layer 205 and the scan electrode 202a, 202b and the sustain electrode 203a, 203b are covered with one or more upper dielectric layers 204 that limits a discharge current and provides insulation between the electrode pairs. A protection layer 206 having deposited magnesium oxide (MgO) thereon is deposited on the upper dielectric layer 204 in order to facilitate discharge conditions. The adhesive agent 207 and the transparent electrode 202a, 203a can be formed using an ITO material.

In the rear glass substrate 210, barrier ribs 214 of a stripe form (or a well form), for forming a plurality of discharge spaces, i.e., discharge cells are arranged in parallel. Furthermore, the plurality of address electrode 211, which perform an address discharge to generate vacuum ultraviolet rays, are disposed parallel to the barrier ribs 214.

R, G and B phosphor layers 215 that radiate a visible ray for displaying images during an address discharge are coated on a top surface of the rear glass substrate 210. A lower dielectric layer 212 for protecting the address electrode 211 is formed between the address electrode 211 and the phosphor layers 215.

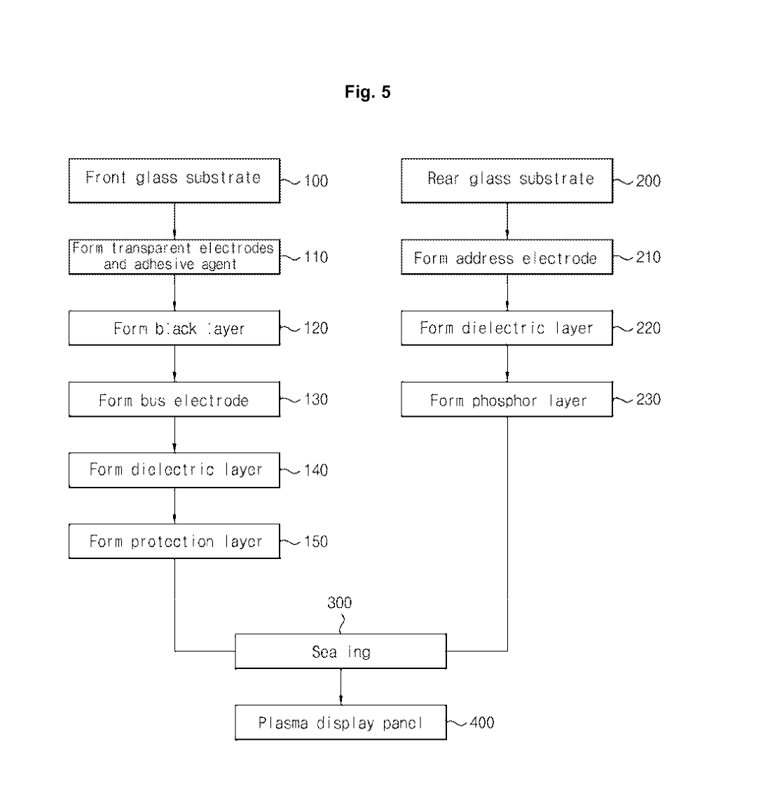

A method of manufacturing the plasma display panel constructed above will be described below with reference to FIG. 5.

FIG. 5 is a flowchart illustrating a method of manufacturing a plasma display panel according to an embodiment of the present invention.

The method of manufacturing the plasma display panel comprises a front panel manufacturing process as shown on the left side of FIG. 5, a rear panel manufacturing process as shown on the right side of FIG. 5, and an assembly process comprising a sealing process, etc. as shown at the bottom of FIG. 5.

The front panel manufacturing process arranged on the left side of FIG. 5 will be first described below. A front glass substrate serving as a base material of a front panel is prepared (100). A transparent electrode and an adhesive agent are formed on the front substrate (110). A black layer paste is then coated on the front glass substrate comprising the transparent electrode and the adhesive agent to form a black layer (120).

Thereafter, a bus electrode is formed on the black layer (130). An upper dielectric layer is formed on the front glass substrate comprising the transparent electrode, the black layer and the bus electrode (140). A protection layer formed of MgO, for protecting the electrode is then formed on the upper dielectric layer (150).

The rear panel manufacturing process of the plasma display panel will now be described. A rear glass substrate is first prepared (200). An address electrode crossing sustain electrode pairs formed in the front panel is formed in a rear glass substrate (210). Thereafter, a lower dielectric layer is formed on a top surface of the address electrode (220). A phosphor layer is formed on a top surface of the lower dielectric layer (230).

The front panel and the rear panel fabricated as described above are sealed (300) to form a plasma display panel (400).

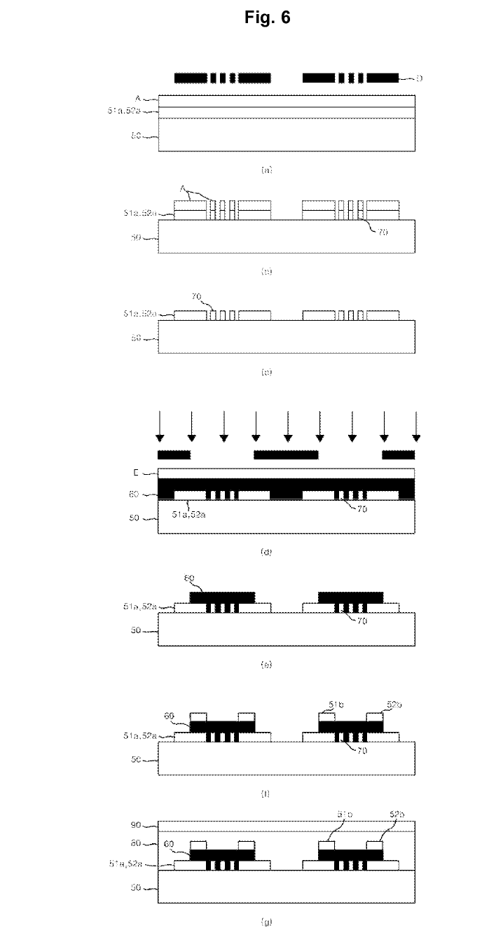

Meanwhile, in the method of manufacturing the plasma display panel as described above according to an embodiment of the present invention, the process of manufacturing the front panel will be described in more detail with reference to FIG. 6.

FIG. 6 is a flowchart illustrating a process of manufacturing a front panel of a plasma display panel according to an embodiment of the present invention.

As shown in FIG. 6, in step (a), ITO made of indium oxide and tin oxide is deposited to a predetermined thickness on a front glass substrate 50, which serves as a display surface on which images will be displayed, in the front panel by means of E-beam or a sputtering method, thus forming a transparent electrode 51a, 52a and an adhesive agent. A photoresist (A) is coated on the transparent electrode 51a, 52a and the adhesive agent.

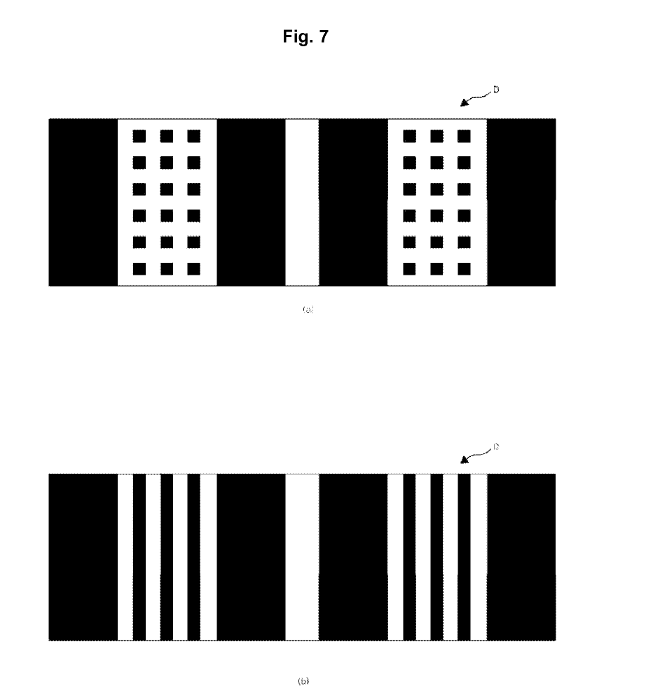

A photomask (D) of a shape (e.g., (a) or (b)) in which a predetermined pattern as shown in FIG. 7 is formed is placed on the photoresist (A) with a predetermined distance therebetween. An exposure process is then performed on the photoresist by irradiating light so that the photoresist is sintered.

The photoresist that has not been sintered is cleaned from the front glass substrate that has undergone the exposure process through a step (b), i.e., a development process. A sandblast or etching process is then performed on the transparent electrode 51a, 52a and the adhesive agent.

Thereafter, in step (c), the photoresist is stripped. Therefore, the transparent electrode 51a, 52a in the scan electrode and the sustain electrode are formed in a discharge region on the front glass substrate 50, and one or more adhesive agents 70 are formed in a non-discharge region of the front glass substrate 50 corresponding to barrier ribs formed in the rear panel.

The adhesive agents 70 formed on the non-discharge region of the front glass substrate 50 can be formed on the front glass substrate 50 in a dot form by means of a photomask of a dot pattern as shown in (a) of FIG. 7, or can be formed on the front glass substrate 50 in a line form by means of a photomask of a line pattern as shown in (b) of FIG. 7.

The dot pattern comprises one or more dots. Furthermore, the line pattern comprises one or more lines.

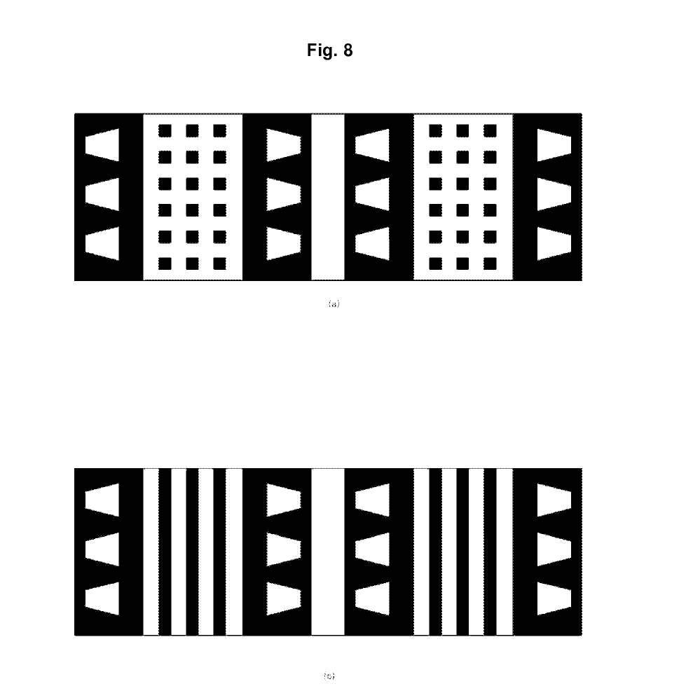

Furthermore, in the transparent electrode 51a, 52a formed in the discharge region of the front glass substrate 50, predetermined grooves are formed in the transparent electrode 51a, 52a using a pattern comprising a predetermined shape in the mask pattern in which the transparent electrode 51a, 52a are formed as shown in (a) or (b) of FIG. 8. It is thus possible to enhance discharge efficiency.

The pattern comprising the predetermined shape can be disposed on the transparent electrode 51a, 52a. The grooves formed in the transparent electrode 51a, 52a can be formed by not only processing, such as laser, but also an exposure process employing a mask pattern.

In step (d), a black layer paste 60 is coated on the front glass substrate 50 comprising the transparent electrode 51a, 52a and the one or more the adhesive agents 70 formed in the non-discharge region. A photoresist (E) is coated on the black layer paste 60 and the aforementioned exposure process is performed on the photoresist (E).

In step (e), the photoresist is stripped from the front glass substrate that has experienced the exposure process through a development process and an etching process, thus forming a black layer 60.

Thereafter, in step (f), a photosensitive silver (Ag) paste is printed on the black layer 60 by a screen printing method. A bus line electrode 51b, 52b are then formed by a photolithography method in the same manner as the above. Thereafter, sintering is performed at a temperature of about 550° C. to form scan electrode and sustain electrode.

Thereafter, in step (g), a dielectric substrate paste is coated on the front glass substrate in which the scan electrode, the sustain electrode and the black layer 60 are formed and is then dried. A sintering process is then performed at a temperature of 500 to 600° C. to form a dielectric layer 80. A protection layer 90 formed of MgO is formed on the entire surface of the dielectric layer 80 by means of a CVD method, an ion plating method, a vacuum deposition method or the like, thereby completing the front panel of the plasma display panel.

The black layer of the front glass substrate of the plasma display panel fabricated through the above process according to an embodiment of the present invention can have a uniform thickness through enhanced adhesive strength with the top of the front glass substrate. It is thus possible to improve a contrast characteristic.

In the process of manufacturing the plasma display panel, adhesive strength with the black layer and the front glass substrate formed in the front panel is enhanced. Therefore, there are advantages in that the failure rate can be decreased and the production yield can be enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a front glass substrate;
a transparent electrode formed on the front glass substrate in a discharge region;
an adhesive agent formed at least on a portion of the front glass substrate in a non-discharge region; and
a black layer formed on the adhesive agent in the non-discharge region.

2. The plasma display panel as claimed in claim 1, wherein the black layer is further formed on some portion of the transparent electrode.

3. The plasma display panel as claimed in claim 1, further comprising a bus electrode formed on the black layer.

4. The plasma display panel as claimed in claim 3, wherein the adhesive agent and the transparent electrode are formed of an ITO material.

5. The plasma display panel as claimed in claim 4, wherein the adhesive agent has a dot pattern.

6. The plasma display panel as claimed in claim 5, wherein the dot pattern comprises one or more dots.

7. The plasma display panel as claimed in claim 4, wherein the adhesive agent has a line pattern.

8. The plasma display panel as claimed in claim 7, wherein the line pattern comprises one or more lines.

9. The plasma display panel as claimed in claim 1, wherein the transparent electrode comprises a pattern comprising a groove.

10. The plasma display panel as claimed in claim 9, wherein the pattern comprising the groove comprises one or more grooves.

11. A method of manufacturing a plasma display panel comprising a front panel, wherein a process of forming the front panel comprises the steps of:
(a) coating a transparent electrode paste and an adhesive paste on a glass substrate;
(b) disposing a mask on the transparent electrode and the adhesive agent;
(c) irradiating a top surface of the mask with a amount of light to form a transparent electrode pattern and a adhesive pattern; and
(d) coating a black paste on the transparent electrode pattern and the adhesive pattern to form a black layer.

12. The method as claimed in claim 11, wherein the mask comprises a dot pattern.

13. The method as claimed in claim 12, wherein the dot pattern is disposed at a location where the black layer is formed.

14. The method as claimed in claim 11, wherein the mask comprises a line pattern.

15. The method as claimed in claim 14, wherein the line pattern is disposed at a location where the black layer is formed.

16. The method as claimed in claim 11, wherein the mask comprises a pattern comprising a groove.

17. The method as claimed in claim 16, wherein the pattern comprising the groove is located on the transparent electrode.
